(19) United States
(12) Patent Application Publication
(10) Pub. No.: US 2007/0173334 A1
(43) Pub. Date: Jul. 26, 2007

(54) Video game instruction card holder

(76) Inventors: David Whitby, Salt Lake City, UT (US); David Trevino, Bountiful, UT (US)

Correspondence Address: VAN COTT, BAGLEY, CORNWALL & MCCARTHY, P.O. BOX 45340, SALT LAKE CITY, UT, 84145-0340, US

(21) Appl. No.: 11/656,165

(22) Filed: Jan. 22, 2007

Related U.S. Application Data
(60) Provisional application No. 60/760,643, filed on Jan. 20, 2006.

(51) Int. Cl. G06F 19/00

(52) U.S. Cl. 463/47

(57) ABSTRACT

An instruction card holder system for supporting an instruction card or the like on a video game control device for visual reference during operation of a video game. The instruction card holder system includes a main body having a first end configured for removable attachment of the main body to the video game control device and a second end configured for removable attachment of an instruction card or the like to the main body.

### RELATED APPLICATIONS

This present application claims priority to U.S. Provisional Patent Application No. 60/760,643, entitled “Video Game Instruction Card Holder,” filed Jan. 20, 2006.

### TECHNICAL FIELD OF THE INVENTION

The present invention relates to holder systems, with specific application to card holder systems for supporting an instruction card or the like on the body or shell of a video game control device for visual reference to the card during operation of the video game.

### BACKGROUND OF THE INVENTION

Video games have reached a level of complexity where it is helpful for the user to have immediate and convenient reference to game instructions, clues, hints or the like during operation of the game. Toward this end, it is not always convenient, and is oftentimes inconvenient, to look away from the video game monitor or control device during operation of the game in order to refer to an instruction manual or other means for the desired information. The present invention obviates this drawback by providing a means for the user to conveniently refer or otherwise consult the desired information while operating the video game.

### SUMMARY OF THE INVENTION

An instruction card holder system is removably attachable to a video game control device for supporting a video game instruction card. The system comprises a main body having a first end configured for removable attachment of the main body to the video game control device and a second end configured for removable attachment of the video game instruction card to the main body.

One embodiment of the main body includes a substantially flat structure having a length that is defined by the surface length of the main body between the first end and the second end, with the main body being curved along a portion of the length. Alternative embodiments contemplate the main body being substantially rectangular in cross section along a portion of the length of the main body.

One embodiment of the main body comprises a clip structure proximate the second end for removably attaching the video game instruction card to the main body. The clip structure comprises a first prong located adjacent a first side of the main body proximate the second end, a second prong located adjacent a second side of the main body proximate the second end, and a third prong located intermediate the first prong and the second prong. One embodiment of the clip structure includes each of the first, second and third prongs having a first end that is integrally connected to the main body. Other embodiments include the third prong as being S-shaped along its length.

In one embodiment, the main body comprises an orifice structure proximate the first end for removably attaching the main body to the video game control device. The orifice structure is configured to slidingly connect with correspondingly shaped male structure that extends outwardly from the video game control device. Other embodiments include the male structure positioned on the main body and corresponding female structure positioned on the video game control device. Yet other embodiments contemplate the main body being formed integrally with the video game control device.

### BRIEF DESCRIPTION OF THE DRAWINGS

FIG. 1 illustrates a perspective view of an instruction card holder of the present invention;

FIG. 2 illustrates a side view of an instruction card holder of the present invention;

FIG. 3 illustrates a top view of an instruction card holder of the present invention;

FIG. 4 illustrates a rear view of an instruction card holder of the present invention;

FIG. 5 illustrates a perspective view of an instruction card holder of the present invention attached to a video game control device and having an instruction card attached to the holder; and

FIG. 6 illustrates a side cutaway view of a portion of the instruction card holder of the present invention attached to a portion of a video game control device.

### DETAILED DESCRIPTION OF THE INVENTION

Generally, the present invention relates to an instruction card holder system that is suitable for supporting an instruction card or the like on a video game control device for visual reference during operation of a video game. The instruction card holder system includes a main body having a first end configured for removable attachment of the main body to the video game control device and a second end configured for removable attachment of an instruction card or the like to the main body. Details of various embodiments of the present invention are set forth below.

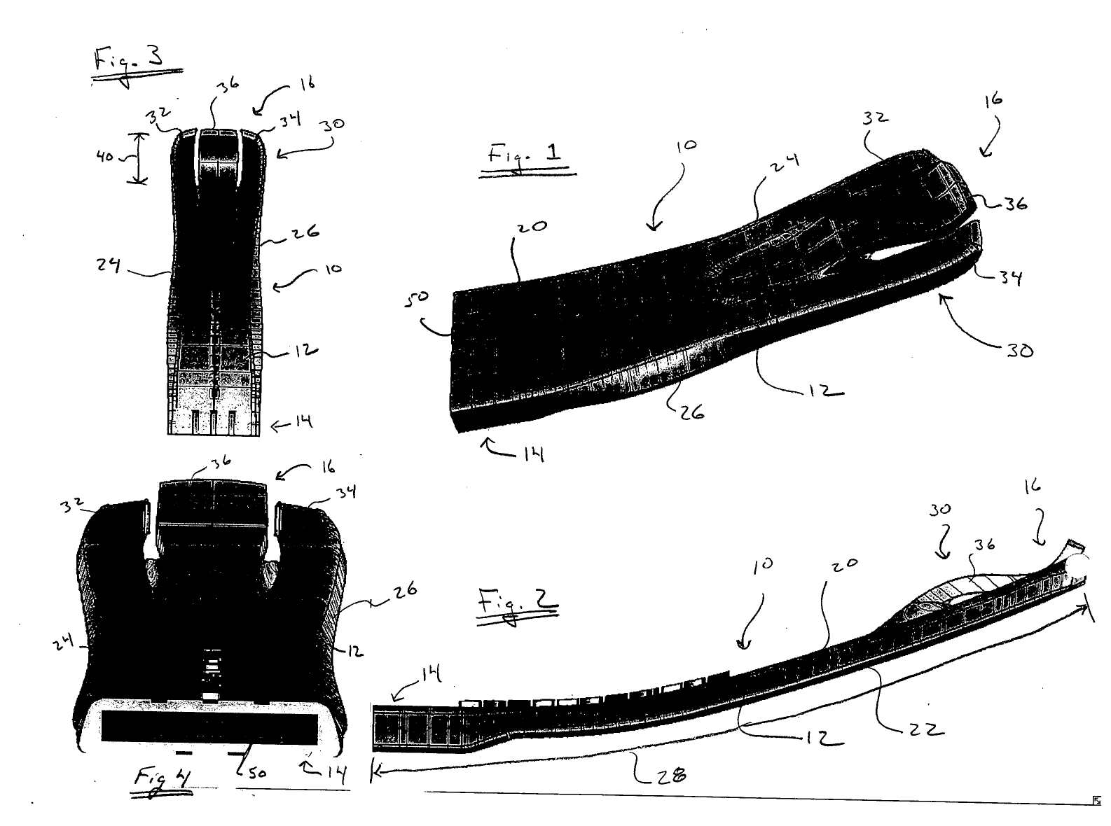

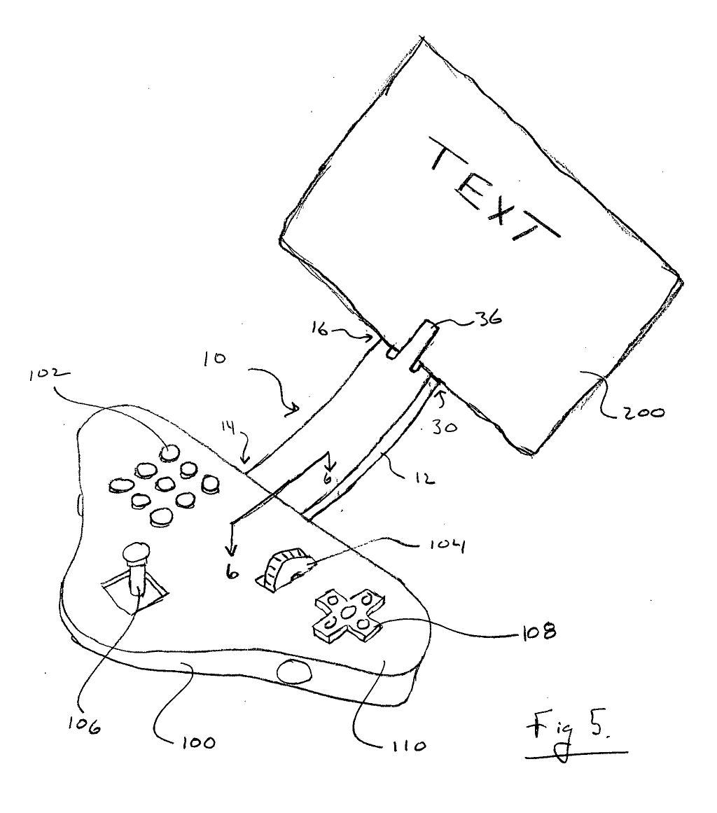

FIGS. 1-6 illustrate various views of an instruction card holder 10 of the present invention and its mode of use with a video game control device. In general, the instruction card holder 10 comprises a main body 12 having a first end 14 configured for removable attachment of the main body 12 to a video game control device 100, and a second end 16 configured for removable attachment of an instruction card 200 to the main body 12. In one embodiment, the instruction card holder 10 is constructed from molded plastic, but other materials, such as, for example, aluminum may be used in constructing the device.

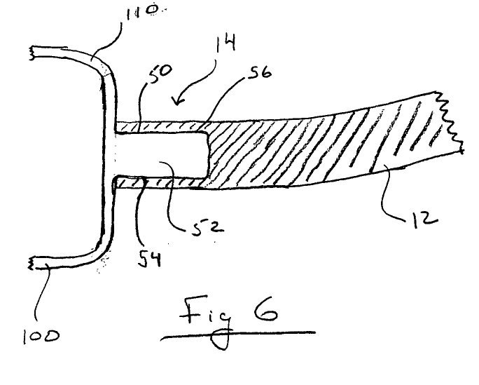

Referring specifically to FIG. 5, a video game control device 100 is illustrated in generic form, and is shown to include standard input control mechanisms that a user might expect to encounter on such devices—e.g., a series of buttons 102, a finger wheel 104, a joy stick 106, and a directional pad 108. The instruction card 200 contains information informing the user how to play the video game, and may include, for example, information concerning game instructions, cheats, codes and “Easter eggs.” The instruction card may further contain advertising information or similar printed media. Although the instruction card is illustrated as being rectangular in shape, it is contemplated that any size or shape card may be used with the present invention. An alternative to the “static”—i.e., printed matter—instruction card 200 includes a screen that can be battery-powered and configured for “static” or “dynamic” display of information. The “static” non-changing data or “dynamic” data—i.e., words or figures that change over time—appearing on the screen is input to the device by, for example, a memory card, SIM card or a memory chip. Such memory devices would likely be provided along with the video game or sold separately by the video-game maker or third parties.

Referring again to FIGS. 1-4, one embodiment of the main body 12 comprises an upper surface 20, a lower surface 22, a first side 24 and a second side 26. The main body 12 has a length 28 which is defined by the approximate distance along the upper surface 20 or lower surface 22 between the first end 14 and the second end 16. The main body 12 is generally flat on the upper and lower surfaces 20, 22, and includes a degree of curvature sufficient to position the instruction card 200 at a convenient location for the user. The degree of curvature ultimately depends on the size and shape of the video game control device 100 and the point and angle of attachment of the first end 14 of the main body 12 to the shell of the video game control device 100. Although the embodiment illustrated in FIGS. 1-5 is presented with only a small degree of upward curvature, it is contemplated that greater degrees of curvature along the length 28 may be suitable for other video game control devices—e.g., upwards of 90 degrees overall from the first end 14 to the second end 16. In other embodiments, the main body 12 is contemplated as comprising two substantially straight portions that are joined intermediate the first end 14 and the second end 16 to form an angled structure—e.g., the entire curvature of the main body 12 is confined to a small region of the main body 12 intermediate the first end 14 and the second end 16, rather than occurring gradually along the length 28.

Still referring to FIGS. 1-5, one embodiment of the main body 12 includes a second end 16 having a three piece prong structure 30. The three prong structure 30 includes a first prong 32 located on the first side 24 of the main body 12, a second prong 34 located on the second side 26 of the main body 12, and a third prong 36 located intermediate the first prong 32 and the second prong 36. Each of the first, second and third prongs 32, 34, 36 have first ends that are formed integral with the main body 12. In one embodiment, the third prong 36 is slightly S-shaped along its length 40. As illustrated in FIG. 5, the slight S-shape curve of the third prong 36 facilitates secure gripping of the instruction card between the third prong 36 and each of the first and second prongs 32, 34. Other embodiments of the holder 10 contemplate alternative means for gripping or otherwise securing the instruction card to the main body 12, such as, for example, non-permanent glue or Velcro sections that can be used to removably attach the instruction card 200 to a portion of the main body 12 adjacent the second end 16.

Still referring to FIGS. 1-5, one embodiment of the main body 12 includes a first end 14 having an orifice structure 50. The orifice structure 50 has an inner wall 56 that is configured to tightly engage with corresponding male structure that extends from the shell 110 of the video game control device 100. Referring specifically to FIGS. 5 and 6, for example, the first end of the main body 12 is illustrated as being attached to a protruding portion 52 of the shell 110 of the video game control device 100. The protruding portion 52 has an outer wall 54 that is configured to tightly engage with the inner wall 56 of the orifice structure 50. In one embodiment, the protruding portion 52 is formed integrally with the shell 110 of the video game control device 100. Alternative embodiments contemplate the protruding portion 52 being secured to the shell 110 by any suitable means, such as, for example, an adhesive. Still further embodiments contemplate reversal of the orifice structure 50 and the protruding portion 52. More specifically, those skilled in the art should appreciate that the first end 14 of the main body 12 may comprise, alternatively, suitably formed male structure that is configured to tightly engage corresponding female structure positioned at a suitable location on or within the shell 110 of the video game control device 100. In a still further embodiment, the main body 12 can be formed integrally with the shell 110 of the video game control device 100. This latter alternative, of course, would mean that the holder is permanently affixed to the video game control device 100. In certain circumstances, such mode of permanent affixation may be desirable over the above described means of removable attachment.

Further embodiments of the holder 10 include the use of an LCD display, LED indicators or audio speakers incorporated into the main body 12. Such displays, indicators or speakers may be connected by either wire or wireless means to the video game control device or the video game monitor and may be used, for example, as auxiliary score keeping or indicator means, separate and apart from that which is commonly displayed on the video monitor. Further embodiments contemplate incorporation of three dimensional shapes or figures onto the upper or lower surface of the main body 12. Three dimensional likenesses of athletes, celebrities, game characters or the like may, for example, be incorporated into the main body for use as advertising or branding purposes. It should be appreciated, moreover, that such likenesses may also be incorporated into the instruction card for similar purposes.

While certain embodiments and details have been included herein and in the attached invention disclosure for purposes of illustrating the invention, it will be apparent to those skilled in the art that various changes in the methods and apparatuses disclosed herein may be made without departing form the scope of the invention, which is defined in the appended claims.

What is claimed is:

1. An instruction card holder system removably attachable to a video game control device for supporting a video game instruction card, comprising:
a main body having a first end configured for removable attachment of the main body to the video game control device and a second end configured for removable attachment of the video game instruction card to the main body.

2. The instruction card holder system of claim 1, wherein a portion of the main body is comprised of a substantially flat structure.

3. The instruction card holder system of claim 1, wherein the main body has a length defined by the first end and the second end and wherein the main body is curved along a portion of the length.

4. The instruction card holder system of claim 1, wherein the main body has a length defined by the first end and the second end and wherein the main body is substantially rectangular in cross section along a portion of the length.

5. The instruction card holder system of claim 1, wherein the main body comprises a clip structure proximate the second end for removably attaching the video game instruction card to the main body.

6. The instruction card holder system of claim 5, wherein the main body includes a first side and a second side proximate the second end and wherein the clip structure comprises:
a first prong located adjacent the first side of the main body proximate the second end,
a second prong located adjacent the second side of the main body proximate the second end, and
a third prong located intermediate the first prong and the second prong.

7. The instruction card holder system of claim 6, wherein each of the first, second and third prongs have a first end that is integrally connected to the main body.

8. The instruction card holder system of claim 6, wherein the third prong is S-shaped along its length.

9. The instruction card holder system of claim 1, wherein the main body comprises an orifice structure proximate the first end for removably attaching the main body to the video game control device.

10. The instruction card holder system of claim 9, wherein the orifice structure is configured to slidingly connect with correspondingly shaped male structure that extends outwardly from the video game control device.

11. The instruction card holder system of claim 1, further comprising a video game instruction card removably secured to the second end of the main body.

12. The instruction card holder system of claim 1, further comprising a dynamic data screen removably secured to the second end of the main body.

13. The instruction card holder system of claim 12, further comprising a battery for supplying power to the dynamic data screen.

14. The instruction card holder system of claim 12, further comprising a memory device for supplying data for projection on the screen.

15. The instruction card holder system of claim 1, wherein a portion of the main body is constructed using plastic.

16. The instruction card holder system of claim 1, wherein a portion of the main body is constructed using aluminum.

17. The instruction card holder system of claim 12, wherein the dynamic data screen is incorporated into a frame that is integral with the main body.

18. The instruction card holder system of claim 1, wherein the first end of the main body is configured for attachment to a video game control device configured for control of one of the group consisting of Playstation 2, Xbox and Xbox 360.

19. The instruction card holder system of claim 1, further comprising a static data screen removably secured to the second end of the main body.

20. The instruction card holder system of claim 19, further comprising a memory device for supplying data for projection on the screen.
